(19) United States
(12) Patent Application Publication
(10) Pub. No.: US 2010/0060470 A1
(43) Pub. Date: Mar. 11, 2010

(54) FAILURE CAUSE IDENTIFYING DEVICE AND METHOD FOR IDENTIFYING FAILURE CAUSE

(76) Inventor: Hiroshi MATSUSHITA, Hiratsuka-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/546,492

(22) Filed: Aug. 24, 2009

(30) Foreign Application Priority Data
Sep. 8, 2008 (JP) 2008-229748
Feb. 9, 2009 (JP) 2009-27119

(51) Int. Cl. G08B 21/00

(52) U.S. Cl. 340/653

(57) ABSTRACT

A failure cause identifying device has a device parameter acquisition part configured to acquire a device parameter indicative of an operating state of a manufacturing device, an alarm generator configured to generate a device alarm with respect to the device parameter in accordance with a predetermined rule during the operation of the manufacturing device, a trouble acquisition part configured to acquire information relating to at least a part of troubles occurred in the manufacturing device, a significance detector configured to detect significance of a relationship between the device alarm and the trouble, and a significance judging part configured to judge whether or not a relationship between the device parameter and the trouble is significant based on the significance detected by the significance detector.

### CROSS REFERENCE TO RELATED APPLICATIONS

This application is based upon and claims the benefit of priority from the prior Japanese Patent Application No. 2008-229748, filed on Sep. 8, 2008, and No. 2009-27119, filed on Feb. 9, 2009 the entire contents of which are incorporated herein by reference.

### BACKGROUND OF THE INVENTION

1. Field of the Invention

The present invention relates to a failure cause identifying device and method for identifying a failure cause in a manufacturing process.

2. Related Art

In a manufacturing process of a semiconductor integrated circuit, device parameters (EES (Equipment Engineering System) data) representing various operating states of a semiconductor manufacturing device are monitored to control the state of the semiconductor manufacturing device. Since the change in the state of the semiconductor manufacturing device appears as the change in the device parameters, abnormality in the semiconductor manufacturing device can be detected by monitoring the device parameters and statistically controlling the process (SPC: Statistical Process Control) (JP-A No. 11 (1999)-345752(Kokai)).

However, there are some problems upon monitoring the device parameters of the semiconductor manufacturing device based on a conventional SPC. One of the problems is that the SPC generates alarms so frequently that the alarms cannot be practically dealt with when an extremely large number of device parameters of the semiconductor manufacturing device have to be monitored, or when criterion to detect the abnormality is loose. There is another problem that all alarms generated by the SPC do not necessarily relate to troubles.

There is further another problem that the alarm truly relating to the trouble may be missed when the criterion of the SPC to detect the abnormality is tightened to decrease the number of alarms apparently.

It is desirable that the device parameters are measured and acquired as abundantly as possible so that the condition of the semiconductor manufacturing device can be monitored as widely as possible. However, due to various restrictions, it is difficult to acquire all device parameters concerning the device state. Therefore, when some troubles occur, the trouble cause is not always proved by analyzing the device parameters. Thus, there is a problem that an engineer takes useless time to analyze the device parameters when many troubles occur, because it is difficult to identify the device parameter relating the trouble cause. The above problems can also occur when the abnormality is detected in various manufacturing devices other than the semiconductor manufacturing device.

### SUMMARY OF THE INVENTION

According to one aspect of the present invention, a failure cause identifying device, comprising:

a device parameter acquisition part configured to acquire a device parameter indicative of an operating state of a manufacturing device;

an alarm generator configured to generate a device alarm with respect to the device parameter in accordance with a predetermined rule during the operation of the manufacturing device;

a trouble acquisition part configured to acquire information relating to at least a part of troubles occurred in the manufacturing device;

a significance detector configured to detect significance of a relationship between the device alarm and the trouble; and

a significance judging part configured to judge whether or not a relationship between the device parameter and the trouble is significant based on the significance detected by the significance detector.

According to the other aspect of the present invention, a failure cause identifying method comprising the steps of:

acquiring a device parameter indicative of an operating state of a manufacturing device;

generating a device alarm with respect to the device parameter in accordance with a predetermined rule during the operation of the manufacturing device;

acquiring information relating to at least a part of troubles occurring in the manufacturing device;

detecting significance of a relationship between the device alarm and the trouble; and

judging whether or not the relationship between the device parameter and the trouble is significant based on the significance.

### BRIEF DESCRIPTION OF THE DRAWINGS

FIG. 1 is a block diagram showing a schematic structure of a semiconductor manufacturing system having a failure cause identifying device 20 according to a first embodiment of the present invention;

FIG. 2 is a flowchart showing an example of the processing operations of the semiconductor manufacturing system having the failure cause identifying device 20 of FIG. 1;

FIG. 3 is a graph showing an example of the value range abnormality;

FIG. 4 is a graph showing an example of the trend abnormality;

FIG. 5 is a graph showing an example of the deviation abnormality;

FIG. 6 is a graph showing an example of the binary abnormality;

FIG. 7 is a diagram showing an example of the device alarms generated in a certain day;

FIG. 8 is a diagram showing an example of the results obtained by performing the trouble check on the device alarm list of FIG. 7;

FIG. 9 is a diagram showing an example of the results obtained by comparing, based on FIG. 8, the measured values with the expected values in the cases 1 to 4 to show the relationship between the device alarm and the trouble;

FIG. 10 is a diagram showing an example of a trend chart generated when the relationship between the device alarm of the exposure amount and the trouble of the dimension abnormality rework is significant;

FIG. 11 is a block diagram showing a schematic structure of a semiconductor manufacturing system having the failure cause identifying device 20 according to the second embodiment of the present invention;

FIG. 12 is a flowchart showing an example of the processing operations of the semiconductor manufacturing system having the failure cause identifying device 20 of FIG. 11;

FIG. 13 is a flowchart showing an example of the processing operations of the manufacturing device controller 16;

FIG. 14 is a block diagram showing a schematic structure of a semiconductor manufacturing system having the failure cause identifying device 20 according to the third embodiment of the present invention;

FIGS. 15A and 15B are flowcharts showing an example of the processing operations of the semiconductor manufacturing system having the failure cause identifying device 20 of FIG. 14;

FIG. 16 is a diagram showing an example in which the trouble hitting ratio H(i,j) of the device alarm is categorized based on the combination of the device parameter k and the trouble j;

FIG. 17 is a diagram showing an example in which the importance level and the control range are set with respect to each device alarm i;

FIG. 18 is a graph showing an example of the fluctuation in the device parameter “shift X” in the past three months;

FIG. 19 is a diagram showing an example in which the trouble detection rate D(i,j) is categorized based on the trouble j; and

FIG. 20 is a flowchart showing the operating steps when the device alarm is generated in the manufacturing process.

### DETAILED DESCRIPTION OF THE INVENTION

Hereinafter, embodiments of a failure cause identifying device according to the present invention will be concretely explained with reference to the accompanying drawings.

### First Embodiment

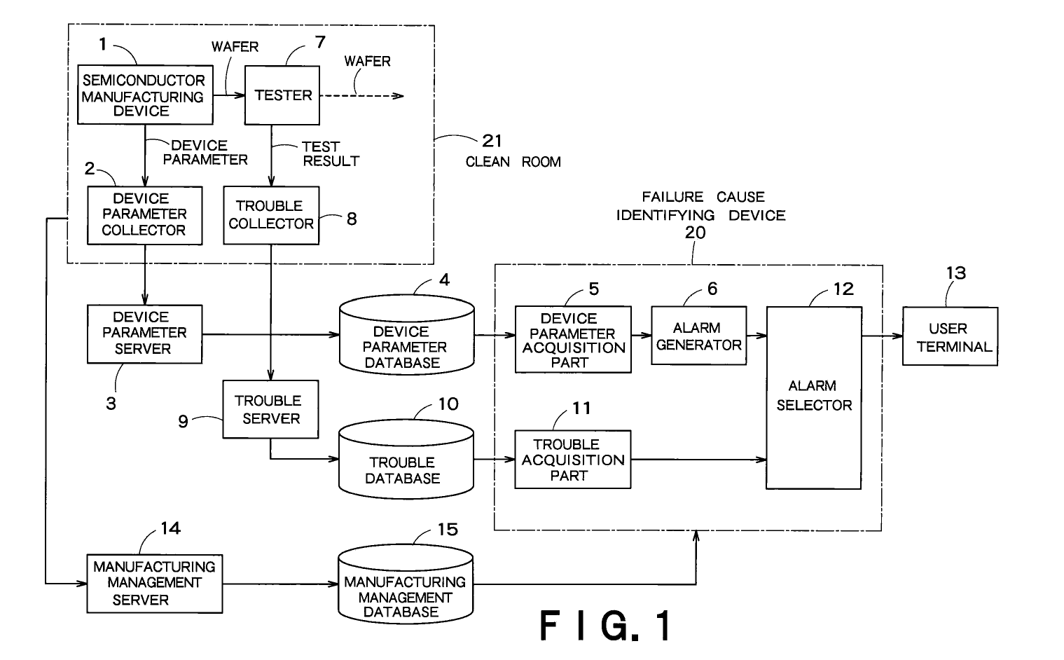

FIG. 1 is a block diagram showing a schematic structure of a semiconductor manufacturing system having a failure cause identifying device 20 according to a first embodiment of the present invention. The failure cause identifying device 20 of FIG. 1 is provided to identify a failure cause of a semiconductor manufacturing device. The semiconductor manufacturing system of FIG. 1 includes a semiconductor manufacturing device 1, a device parameter collector 2, a device parameter server 3, a device parameter database 4, a device parameter acquisition part 5, an alarm generator 6, a tester 7, a trouble collector 8, a trouble server 9, a trouble database 10, a trouble acquisition part 11, an alarm selector 12, a user terminal 13, a manufacturing management server 14, and a manufacturing management database 15.

The device parameter collector 2 is installed in the semiconductor manufacturing device 1 (hereinafter, referred to as a manufacturing device 1) arranged in a clean room 21, and acquires device parameters indicative of various operating states of the manufacturing device 1. The device parameter server 3 stores the device parameters collected by the device parameter collector 2 in the device parameter database 4. The device parameter acquisition part 5 acquires the device parameters stored in the device parameter database 4. The alarm generator 6 generates device alarms based on predetermined rules.

The trouble collector 8 is installed in the tester 7 arranged in the clean room 21, and collects, from the tester 7, the information relating to various troubles occurring in the manufacturing device 1. The trouble server 9 stores, in the trouble database 10, the trouble information collected by the trouble collector 8. The trouble acquisition part 11 acquires the trouble information stored in the trouble database 10.

The alarm selector 12 selects the device alarms generated by the alarm generator 6 and the trouble information acquired by the trouble acquisition part 11 which are highly related to each other, and generates a trend chart indicative of the relationship between the device parameter and the trouble occurrence. The user terminal 13 presents the generated trend chart to a user.

The manufacturing management server 14 manages the entire factory and stores, in the manufacturing management database 15, manufacturing management information such as a manufacturing type, lot number, wafer number, processing date and time, etc. The information stored in the manufacturing management database 15 are used in a process performed by the alarm generator 6 etc. as needed.

In the above described semiconductor manufacturing system having the failure cause identifying device 20 of FIG. 1, the failure cause identifying device 20 includes at least the device parameter acquisition part 5, the alarm generator 6, the trouble acquisition part 11, and the alarm selector 12. The other components can be incorporated into or separated from the failure cause identifying device 20.

Further, although the explanation of FIG. 1 is based on the example in which the manufacturing device 1, the device parameter collector 2, the tester 7, and the trouble collector 8 are arranged in the clean room 21, the arrangement in the clean room 21 can be variously changed. For example, a plurality of semiconductor manufacturing devices or testers can be provided. When a plurality of semiconductor manufacturing devices are provided, the device parameter collector must be installed in each semiconductor manufacturing device. Further, when a plurality of testers are provided, the trouble collector must be installed in each tester.

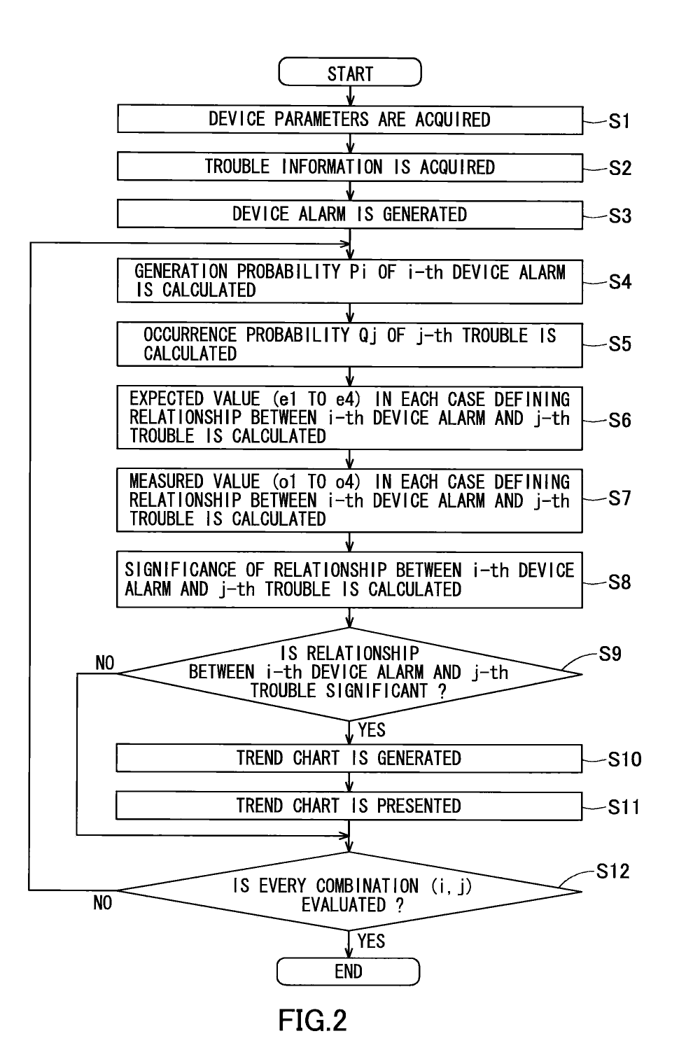

FIG. 2 is a flowchart showing an example of the processing operations of the semiconductor manufacturing system having the failure cause identifying device 20 of FIG. 1. Referring to FIG. 2, the processing operations of the semiconductor manufacturing system having the failure cause identifying device 20 of FIG. 1 will be explained based on an example in which a lithography process is performed by using an exposure device as the manufacturing device 1.

First, the device parameter collector 2 collects the device parameters from the manufacturing device 1 (exposure device), and the device parameter server 3 stores the collected device parameters in the device parameter database 4 (Step S1). The device parameters of the exposure device include exposure amount, synchronization accuracy, etc., and the device parameters in a target analysis period, which is a period to identify a failure cause, are stored in the device parameter database 4 on a wafer basis. In the present embodiment, the number of device parameters to be acquired is 250, and the length of the target analysis period is 1 month. Note that the data can be acquired not only on a wafer basis but also on an exposure basis, time-series data basis, etc.

Next, the trouble collector 8 collects the information relating to various troubles from the test results of the wafer obtained by the tester 7, and the trouble server 9 stores the collected information in the trouble database 10. Then, the trouble acquisition part 11 acquires the trouble information stored in the trouble database 10 (Step S2). The exposure device suffers troubles such as exposure rework caused by a defect revealed by the exposure results, exposure pattern abnormality revealed by the test results after the completion of exposure, etc.

The trouble collector 8 in the present embodiment collects from various troubles only the troubles requiring rework, categorizes the troubles into three types in accordance with three types of rework causes, namely, pattern dimension abnormality, alignment gap abnormality in a mask etc., and focus abnormality in a light source etc. used in the exposure, and stores the occurrence situation of each rework in the trouble database 10 on a wafer basis. In this way, the trouble acquisition part 11 acquires the information relating to at least a part of troubles occurring in the manufacturing device 1.

The device parameter acquisition part 5 acquires the device parameters stored in the device parameter database 4, and the alarm generator 6 generates the device alarms concerning each acquired device parameter in accordance with predetermined rules to generate the device alarm (Step S3).

There are plural types of device parameters. The concrete content of each device parameter is not particularly specified. In the present embodiment, the following four device alarms are generated concerning each device parameter.

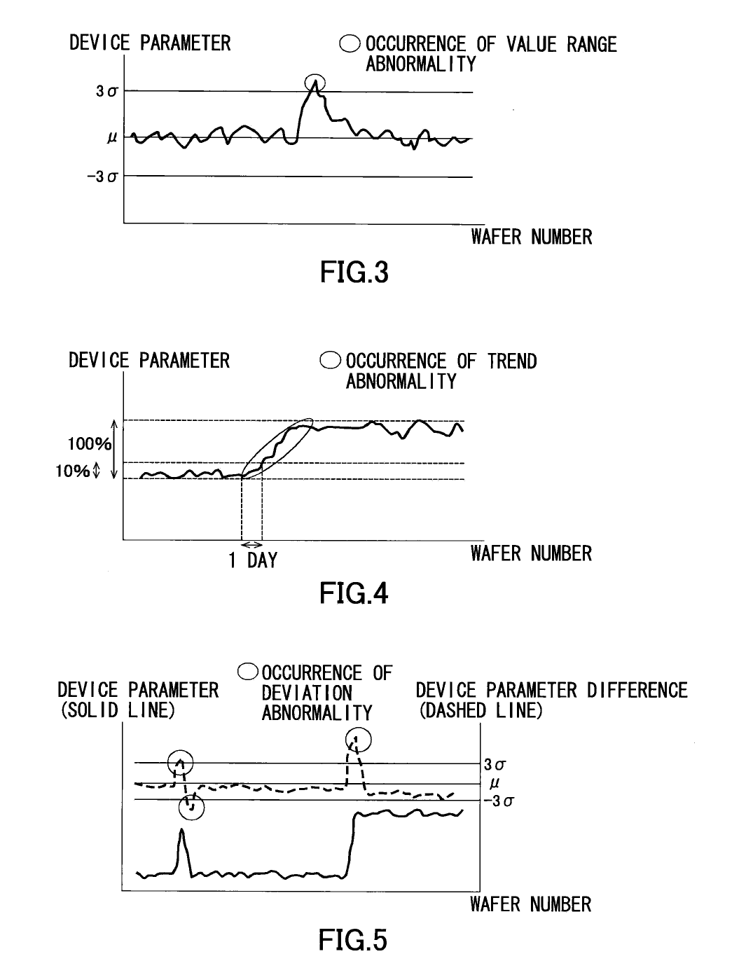

1. Value range abnormality: a mean value (μ) and a standard deviation (σ) of the device parameter at the time of having no trouble are calculated, and when the device parameter exceeds μ±3σ, the wafer is judged to be in the value range abnormality, and the device alarm is generated. FIG. 3 is a graph showing an example of the value range abnormality. The horizontal axis shows the wafer number, and the vertical axis shows the device parameter value. The alarm generator 6 judges that the value range abnormality occurs in the encircled portion in FIG. 3 and generates the device alarm. Alternatively, when the mean value has a certain trend, the alarm generator 6 can generate the device alarm by approximating the trend to a linear function etc. and setting the control range of 3σ based on the linear expression.

2. Trend abnormality: an interval in which the value range of the device parameter changes by 10% is obtained from the target analysis period, and when the interval in which the value range of the device parameter changes by 10% is shorter than one day, it is determined, based on the manufacturing date information of each wafer stored in the manufacturing management database 15, the trend abnormality has occurred, and the device alarm is generated. FIG. 4 is a graph showing an example of the trend abnormality. The horizontal axis and the vertical axis are the same as FIG. 3. The alarm generator 6 judges that the trend abnormality has occurred in the encircled portion in FIG. 4, because the value range changes by 10% in one day, and generates the device alarm.

3. Deviation abnormality: a mean value (μ) and a standard deviation (σ) of wafer difference of the device parameter at the time of having no trouble are obtained, the wafer immediately after the wafer difference becomes p±3σ or greater, is judged to be in the deviation abnormality, and the device alarm is generated. FIG. 5 is a graph showing an example of the deviation abnormality, and the horizontal axis is the same as FIG. 3. The vertical axis on the left shows the device parameter (solid line graph), and the vertical axis on the right shows the wafer difference (dotted line graph). The values μ and μ±3σ of the wafer difference are shown on the vertical axis on the right. The alarm generator 6 judges that the deviation abnormality occurs in the encircled portions in FIG. 5 and generates the device alarm. Note that the device alarm can be generated in accordance with not only the wafer difference but also lot difference.

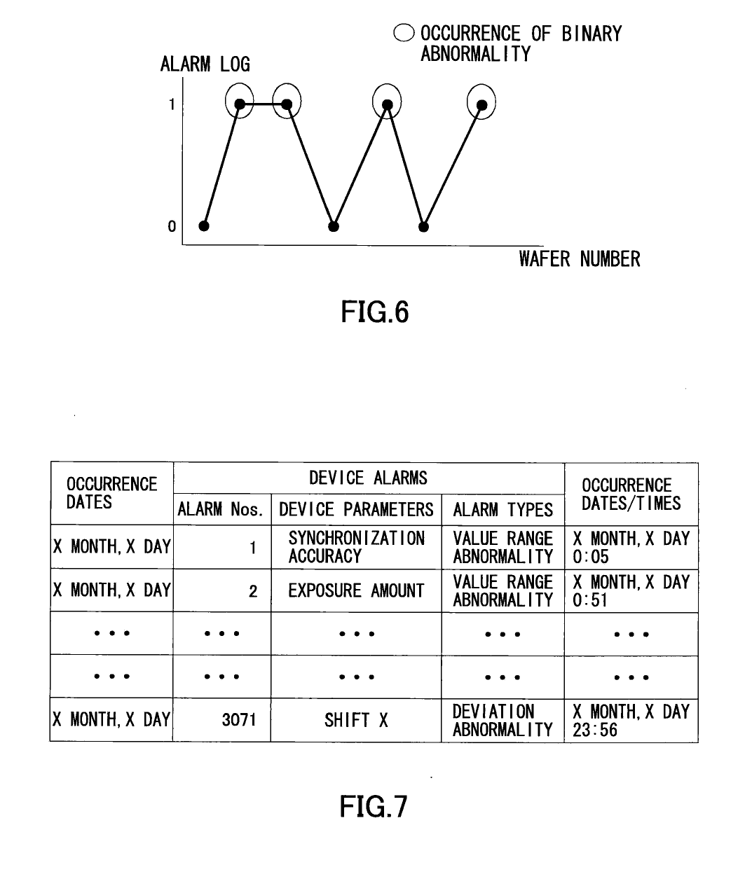

4. Binary abnormality: when a binary device parameter, which express an alarm log generated by the exposure device itself by value of 0 or 1, is equal to one of the values (1, for example), binary abnormality is judged to occur, and the device alarm is generated. FIG. 6 is a graph showing an example of the binary abnormality. The horizontal axis shows the wafer number, and the vertical axis shows the alarm log value generated by the exposure device. The alarm generator 6 judges that the binary abnormality in the wafer having an alarm log value of 1 occurs in the encircled portions in FIG. 6 and generates the device alarm.

Each of these device alarms is only an example, and various types of device alarms can be defined.

FIG. 7 is a diagram showing an example of the device alarms generated in a certain day. In a wafer manufacturing process performed at 0:05 in this day, the device alarm of the value range abnormality is generated concerning the synchronization accuracy. Further, in the wafer manufacturing process performed at 0:51, the device alarm of the value range abnormality is generated concerning the exposure amount. Similarly, FIG. 7 shows that the device alarms are generated totally 3071 times in this day.

Next, the alarm selector 12 obtains the significance of the relationship between the device alarm and the trouble in accordance with the process steps of S4 to S12 shown in FIG. 3. Hereinafter, the processing operations performed by the alarm selector 12 will be sequentially explained. First, a generation probability Pi of an i-th device alarm in the target analysis period is obtained (Step S4). The generation probability Pi of the device alarm is obtained with respect to each combination of device parameter and alarm. That is, i is a value from 1 to 1000 (1000 is obtained by multiplying 250 representing the number of device parameters to be acquired by 4 representing the number of alarm types), and the generation probability Pi of the device alarm is obtained by dividing the number of occurrences of the i-th device alarm by nt representing the number of wafers processed in the target analysis period.

Next, an occurrence probability Qj of a j-th trouble in the target analysis period is obtained (Step S5). j is a value from 1 to 3, which corresponds to the number of trouble types, namely, dimension abnormality rework, alignment gap abnormality rework, and focus abnormality rework. The trouble occurrence probability Qj is obtained by dividing the number of occurrences of the j-th trouble by nt representing the number of wafers processed in the target analysis period.

Further, the following cases 1 to 4 are determined based on the assumption that the generation of the i-th device alarm and the occurrence of the j-th trouble are independent of each other.

Case 1: the i-th device alarm is generated, and the j-th trouble occurs at the same time.

Case 2: only the i-th device alarm is generated, and the j-th trouble does not occur.

Case 3: the i-th device alarm is not generated, and only the j-th trouble occurs.

Case 4: the i-th device alarm is not generated, and the j-th trouble does not occur.

After performing the above process, expected values for the cases 1 to 4 (referred to as e1 to e4, respectively) arising in the target analysis period are obtained by the following equations (1) to (4) (Step S6).

e1=Pi*Qj*nt (1)

e2=Pi*(1−Qj)*nt (2)

e3=(1−Pi)*Qj*nt (3)

e4=(1−Pi)*(1−Qj)*nt (4)

Next, the wafer processed when the device alarm is generated is checked whether or not the troubles occur at the same time based on the information of the manufacturing management database 15, and measured values for the cases 1 to 4 (referred to as o1 to o4, respectively) are obtained (Step S7).

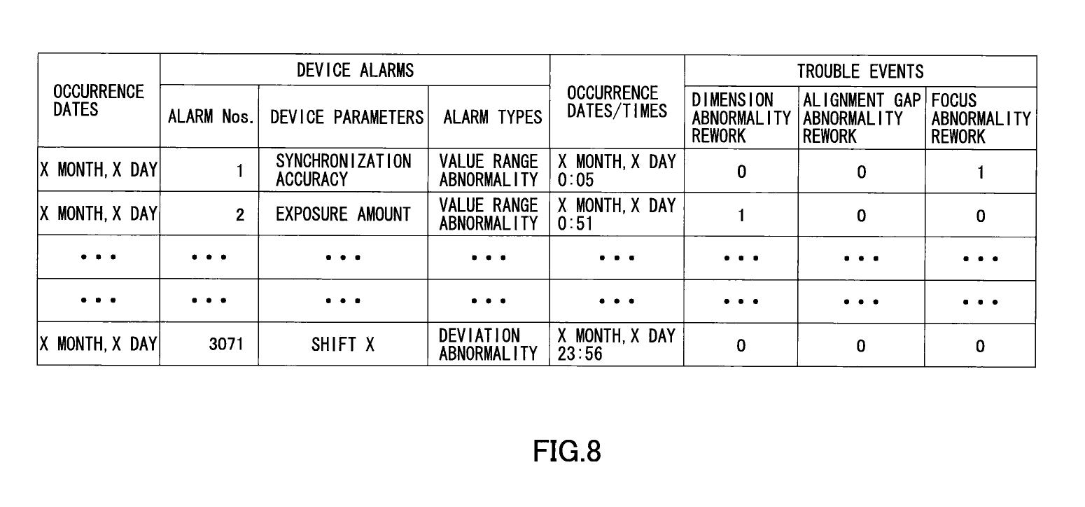

FIG. 8 is a diagram showing an example of the results obtained by performing the trouble check on the device alarm list of FIG. 7. “1” and “0” show the presence and absence of the trouble occurred when the device alarm is generated, respectively. In the wafer manufacturing process performed at 0:05 in this day, the device alarm of the value range abnormality is generated concerning the synchronization accuracy, and the trouble of the focus abnormality rework occurs at the same time. Further, in the wafer manufacturing process performed at 0:51, the device alarm of the value range abnormality is generated concerning the exposure amount, and the trouble of the dimension abnormality rework occurs at the same time. Further, in the wafer manufacturing process performed at 23:56, the device alarm of the deviation abnormality is generated concerning a shift X, and no trouble occurs at the same time.

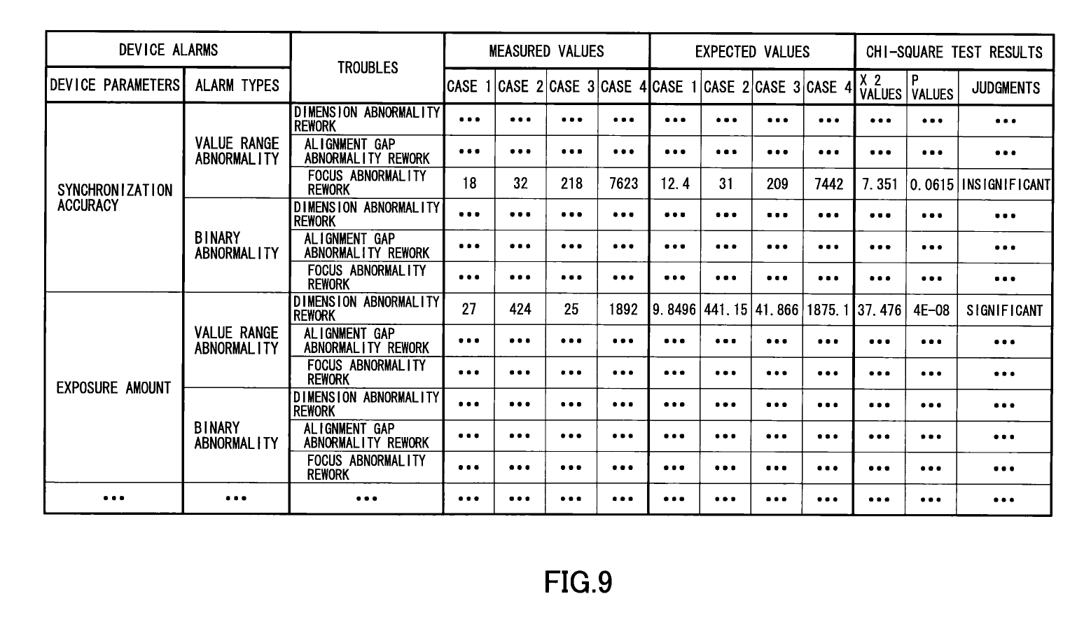

FIG. 9 is a diagram showing an example of the results obtained by comparing, based on FIG. 8, the measured values with the expected values in the above cases 1 to 4 with respect to the device alarm and the trouble. In FIG. 9, only the value range abnormality and the binary abnormality are described in the alarm type category while omitting the trend abnormality and the deviation abnormality, but the trend abnormality and the deviation abnormality are actually included. For example, in the case (case 1) where the device alarm of the value range abnormality concerning the synchronization accuracy is generated, and the trouble of the focus abnormality rework occurs at the same time, the expected value is 12.4, and the measured value (the actual number of the coincidences in the target analysis period) is 18. Similarly, in the case 2, the expected value is 31, and the measured value is 32. In the case 3, the expected value is 209, and the measured value is 218. In the case 4, the expected value is 7442, and the measured value is 7623. Similarly, in FIG. 9, the result of comparing the measured value with the expected value is continuously shown with respect to each combination formed from 1000 types of device alarms and three types of troubles.

Next, referring back to FIG. 2, the alarm selector 12 obtains the significance difference between the measured value and the expected value (Step S8). Step S8 corresponds to a significance detector. In the present embodiment, a chi-square test is used. The value P serving as a test value in the chi-square test is obtained by the following equations (5) and (6).

χ2=Σ(ok−ek)2/ek (5)

P=chidist(χ2, 3) (6)

Here, χ2 represents the chi-square value, k represents 1 to 4, and Σ represents the sum of k=1 to 4. Further, chidist represents the chi-square distribution function, and 3 represents the degree of freedom in this statistical test. ok (o1 to o4 in this example) represents the measured value, and ek (e1 to e4 in this example) represents the expected value.

The values e1 to e4 are calculated based on the assumption that generation of the device alarm and occurrence of the trouble are independent of each other. If this assumption is correct, the values o1 to o4 and the values e1 to e4 approximate each other and the value P approximates 1. On the other hand, if the assumption is not correct, that is, generation of the device alarm and occurrence of the trouble are interrelated, the values o1 to o4 and the values e1 to e4 are apart from each other, and the value P approximates 0.

Accordingly, when the value P is smaller than a predetermined threshold value (0.05, for example), the relationship is judged to be significant (Step S9). In the example of FIG. 9, the relationship between the device alarm of the value range abnormality concerning the exposure amount and the trouble of the dimension abnormality rework is judged to be significant.

In the present embodiment, the significance of the relationship between the device alarm and the trouble is judged by the chi-square test. However, the significance can be judged by a different technique, for example, the relationship is judged to be significant when the difference between the expected value and the measured value exceeds a predetermined threshold value.

When the relationship between the device alarm and the trouble is judged to be significant, the alarm selector 12 generates the trend chart indicative of the relationship between the device parameter and the trouble (Step S10) and presents the trend chart to the user terminal 13 (Step S11). How to present the trend chart is not particularly specified. For example, the trend chart can be graphically displayed or numerically displayed in a table format on the screen of the user terminal 13, or the trend chart can be printed by a printer. Step S10 corresponds to a trend chart generator, and Step S11 corresponds to a presentation part.

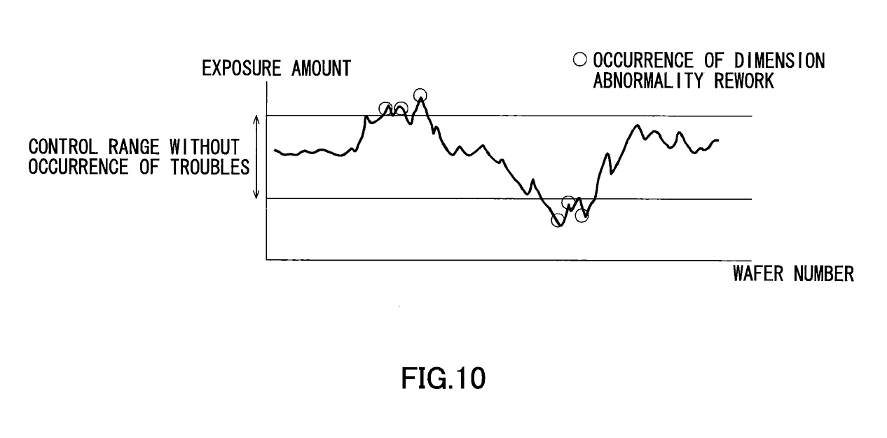

FIG. 10 is a diagram showing an example of a trend chart generated when the relationship between the device alarm of the exposure amount and the trouble of the dimension abnormality rework is significant. The horizontal axis shows the wafer number, and the vertical axis shows the device parameter value concerning the exposure amount. In each of the encircled portions in FIG. 10 indicative of the occurrence of the dimension abnormality rework, the device parameter exceeds the maximum threshold value or falls below the minimum threshold value.

Accordingly, it is found that the dimension abnormality rework occurs due to the abnormality in the exposure amount, and the control range (margin degree) of the exposure amount in which the dimension abnormality rework does not occur is clarified.

In FIG. 10 of the present embodiment, the user terminal 13 graphically presents the trend chart when the significance is recognized. However, the trend chart can be presented by in the order from the strongest relationship between the device alarm and the trouble (in the order from the smallest value P, for example). When a plurality of relationships between the device alarms and the troubles are judged to be significant, or when a plurality of trend charts are presented in the order from the strongest relationship, various presentation methods can be supposed, for example, the plurality of trend charts can be presented at the same time in the order from the smallest value P.

The above Steps S4 to S11 are performed on each combination of the device alarms i and the troubles j. Concretely, the value i is 1 to 1000, and the value j is 1 to 3.

As stated above, in the first embodiment, the device parameters are acquired without narrowing down the device parameter types, and the alarm selector 12 extracts the device alarm having a significant relationship to the trouble among enormous number of device alarms to generate the trend chart indicative of the relationship between generation of the extracted device alarm and occurrence of the trouble, and present the trend chart to the user terminal 13. Accordingly, the device alarm relating to the trouble cause can be accurately and simply extracted, and the manufacturing device 1 can be effectively recovered from the trouble.

### Second Embodiment

In a second embodiment, the manufacturing device automatically controls the manufacturing device based on the relationship between the device alarm and the trouble judged to be significant.

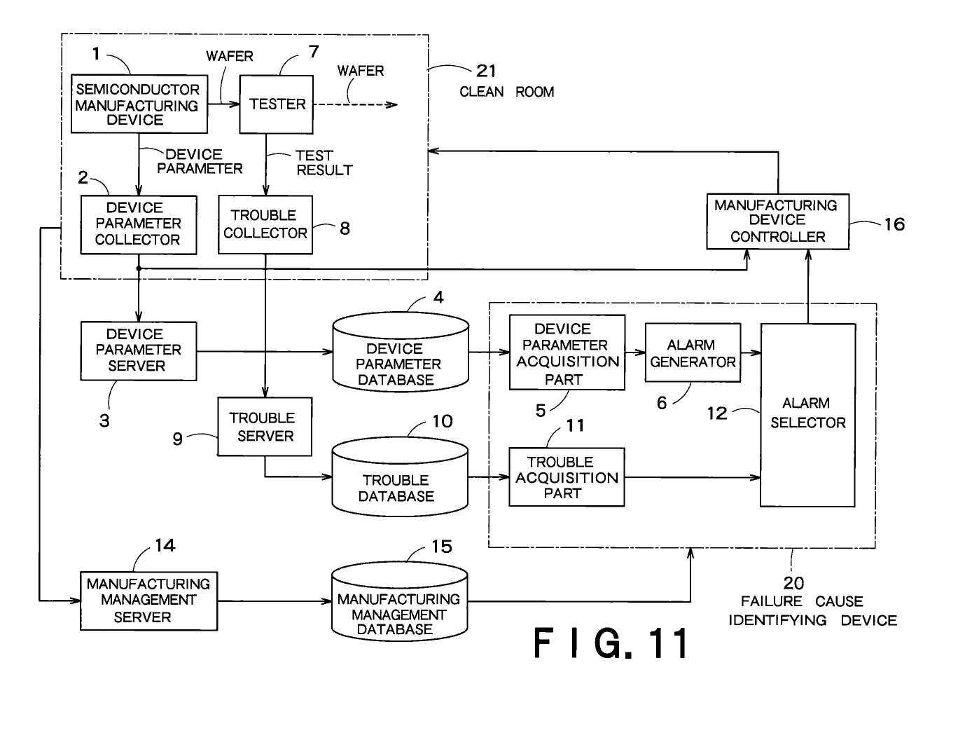

FIG. 11 is a block diagram showing a schematic structure of a semiconductor manufacturing system having the failure cause identifying device 20 according to the second embodiment of the present invention. In FIG. 11, the same numerals are attached to the components common to those in FIG. 1, and the differences will be mainly explained hereinafter. The semiconductor manufacturing system of FIG. 11 has a manufacturing device controller 16 to monitor and control the device parameters of the manufacturing device 1. The manufacturing device controller 16 is provided instead of the user terminal 13 of FIG. 1. The manufacturing device controller 16 can be implemented as an APC (Advanced Process Control) system, for example. Note that the manufacturing device controller 16 can be newly added to the semiconductor manufacturing system FIG. 1 without omitting the user terminal 13.

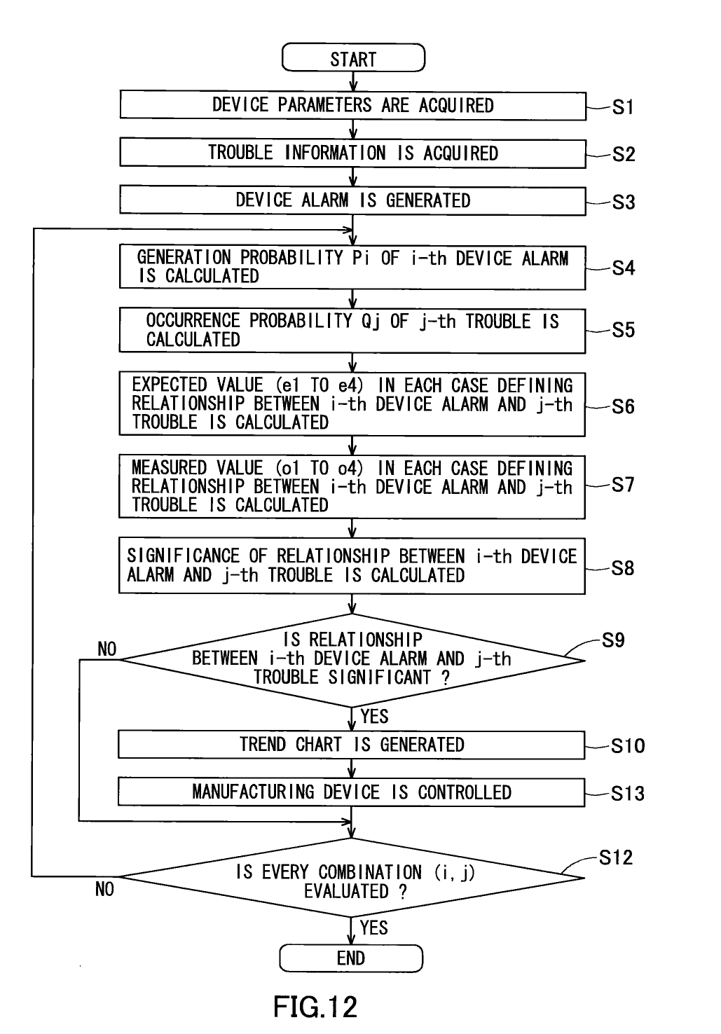

FIG. 12 is a flowchart showing an example of the processing operations of the semiconductor manufacturing system having the failure cause identifying device 20 of FIG. 11. Steps S1 to S10 are common to those in the first embodiment. When the relationship between the device alarm and the trouble is significant, the manufacturing device controller 16 controls a device recipe of the manufacturing device 1 (Step S13). Here, the device recipe represents various setting conditions influencing the semiconductor manufacturing such as temperature, voltage, electric current, etc. of the manufacturing device 1.

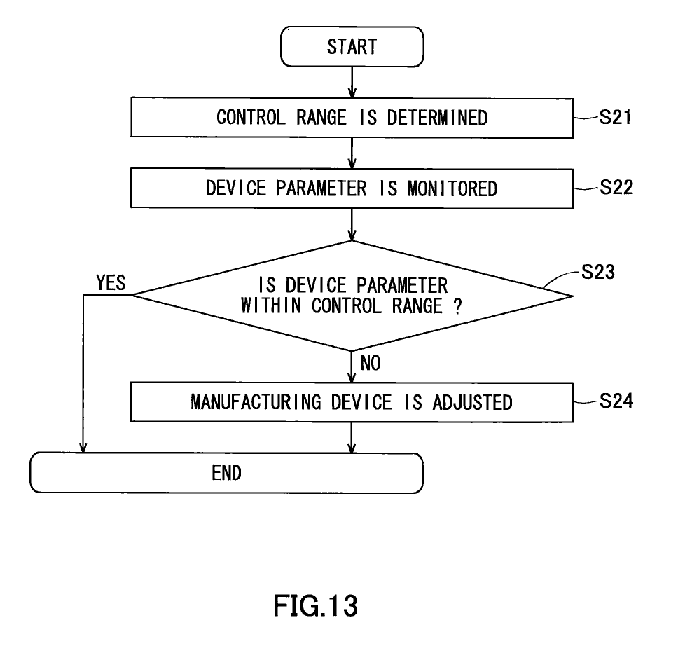

FIG. 13 is a flowchart showing an example of the processing operations of the manufacturing device controller 16. The processing operations of the manufacturing device controller 16 will be explained by using an example in which the trend chart is generated (FIG. 10) based on the assumption that the relationship between the device alarm of the exposure amount and the trouble of the dimension abnormality rework is significant.

First, the control range (margin degree) of the device parameter (exposure amount) for preventing occurrence of troubles is determined based on the trend chart (Step S21). Then, the exposure amount is monitored (Step S22), and it is confirmed whether or not the exposure amount is within the control range (Step S23). When the exposure amount deviates from the control range, the exposure device is adjusted so that the exposure amount stays within the control range (Step S24). Step S22 to S24 can be routinely performed in a predetermined period (manufacturing period of the semiconductor device, for example).

As stated above, according to the second embodiment, the device recipe of the manufacturing device 1 is controlled based on the trend chart indicative of the relationships between the extracted device alarm and the trouble occurrence, by which the device recipe of the manufacturing device 1 can be controlled to prevent occurrence of troubles, and the productivity of the factory can be improved. Further, when the trend chart is updated in the continuous process of a plurality of wafers on manufacturing process, the device recipe can be changed in accordance with the update, which leads to the reduction in fluctuation on manufacture and the improvement in productivity.

### Third Embodiment

In a third embodiment, the device alarms which should be truly monitored is automatically extracted, from a great number of device alarms in the semiconductor manufacturing process, to identify the trouble cause, and the device alarms to be monitored is updated periodically.

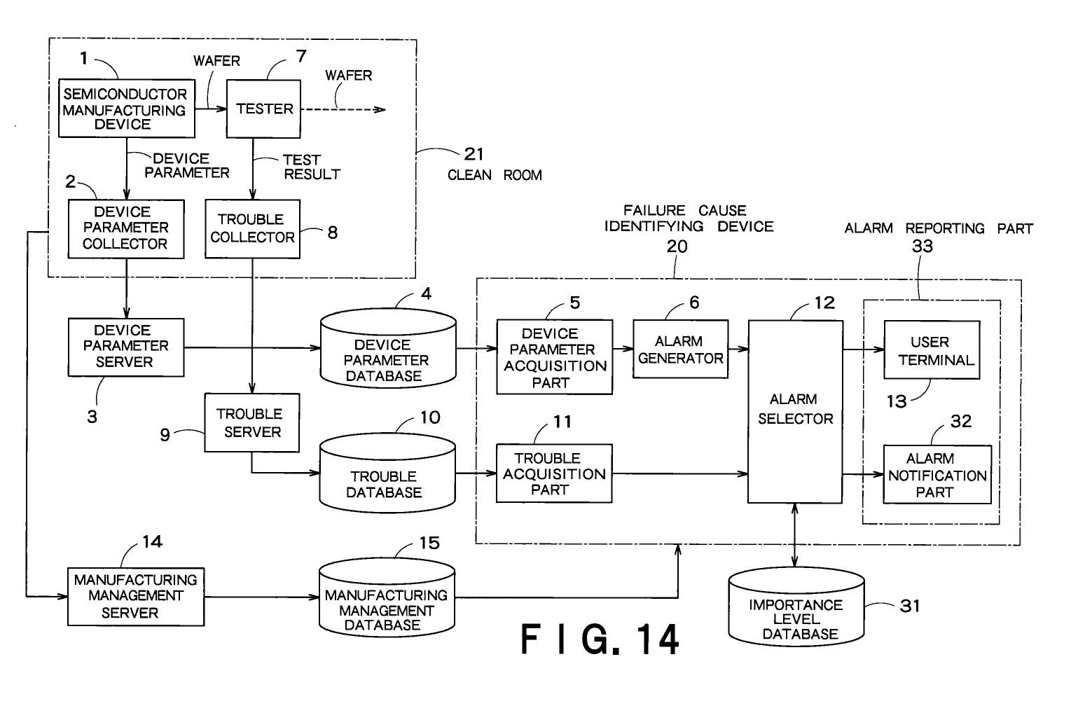

FIG. 14 is a block diagram showing a schematic structure of a semiconductor manufacturing system having the failure cause identifying device 20 according to the third embodiment of the present invention. In FIG. 14, the same numerals are attached to the components common to those in FIG. 1, and the differences will be mainly explained hereinafter. The semiconductor manufacturing system of FIG. 14 further includes an importance level database 31 and an alarm reporting part 33, the alarm reporting part 33 having the user terminal 13 and an alarm notification part 32. Stored in the importance level database 31 are importance level etc. of each device alarm. The alarm reporting part 33 reports (presents) the generation of the device alarm to operators, engineers, etc. that control the manufacturing process etc. in accordance with the importance level of the generated device alarm.

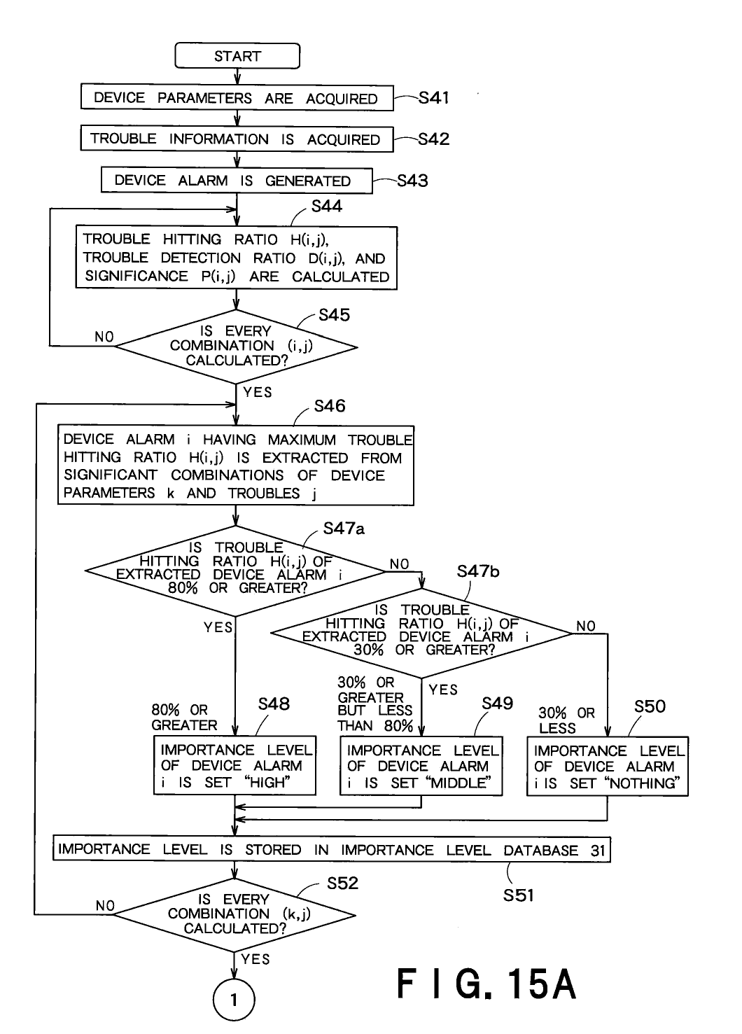

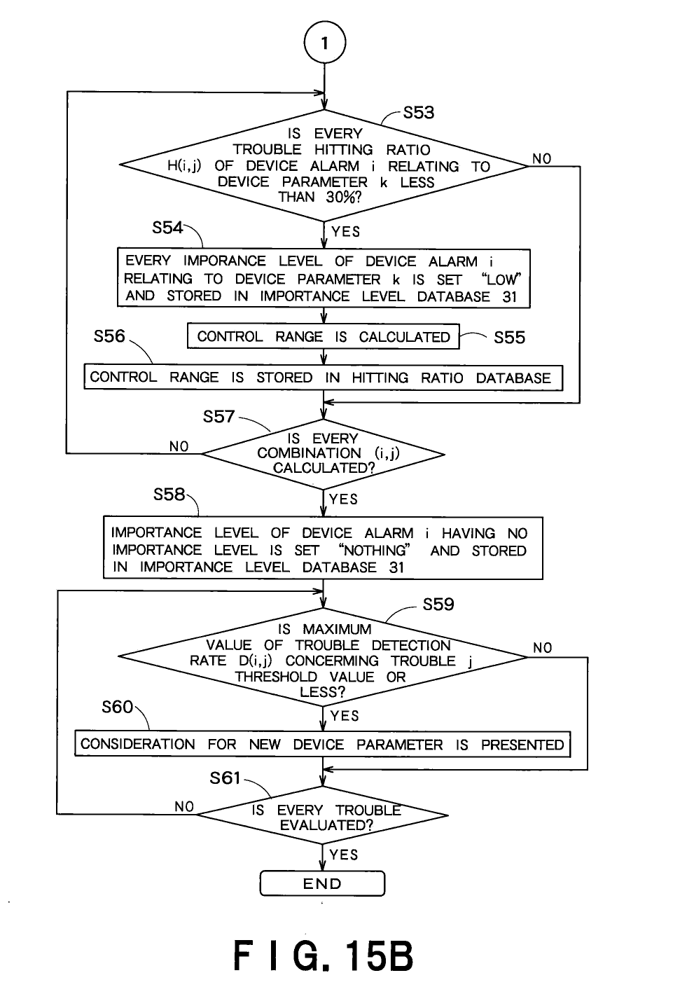

FIGS. 15A and 15B are flowcharts showing an example of the processing operations of the semiconductor manufacturing system having the failure cause identifying device 20 of FIG. 14. FIG. 15A and 15B show the steps to calculate the importance level of each device alarm.

First, as in the first embodiment, the device parameter collector 2 collects 250 device parameters from the manufacturing device 1, and the device parameter server 3 stores the collected device parameters in the device parameter database 4 (Step S41). Next, the trouble collector 8 collects the information relating to various troubles from the test results of the wafer tested by the tester 7, and the trouble server 9 stores the collected information in the trouble database 10. Then, the trouble acquisition part 11 acquires the trouble information stored in the trouble database 10 (Step S42).

In the present embodiment, as in the first embodiment, the trouble collector 8 acquires the trouble information relating to the dimension abnormality rework, the alignment gap abnormality rework, and the focus abnormality rework, and the device parameter database 4 and the trouble database 10 store the device parameters and trouble information acquired during three months, respectively.

Further, the device parameter acquisition part 5 acquires the device parameters stored in the device parameter database 4, and the alarm generator 6 generates the device alarm for each acquired device parameter based on predetermined rules (Step S43). In the present embodiment, four types of alarms, which are similar to those in the first embodiment, are generated by variously changing the generation condition of the alarm. Hereinafter, the detailed explanation will be made.

With respect to the value range abnormality, a mean value (μ) and a standard deviation (σ) of the device parameter at the time of having no trouble are calculated, and when the device parameter exceeds a threshold value of μ±aσ, the wafer is judged to be in the value range abnormality, and the alarm generator 6 generates the device alarm. Here, “a” is a coefficient to adjust the influence of the deviation. The threshold value determined for the occurrence of the value range abnormality has 9 types, which are obtained by selecting the coefficient “a” from a value range of 2 to 6 in 0.5 increments.

With respect to the trend abnormality, an interval in which the value range of the device parameter changes by b % is obtained from the target analysis period (three months), and when the interval in which the value range of the device parameter changes by b % is shorter than c day(s), it is determined, based on the manufacturing date information of each wafer stored in the manufacturing management database 15, that the trend abnormality occurs, and the device alarm is generated by the alarm generator 6. The trend abnormality occurs under 90 types of conditions, the number of types being obtained by multiplying 15 by 6. Here, the value 15 represents that the value b has 15 types of values selected from a value range of 2% to 30% in 2% increments, and the value 6 represents that the value c has 6 types of values selected from a value range of 0.5 day to 3 days in 0.5 day increments.

With respect to the deviation abnormality, a mean value (μ) and a standard deviation (σ) of wafer (or lot) difference of the device parameter at the time of having no trouble are obtained, the wafer immediately after the wafer difference becomes μ±dσ or greater, is judged to be in the deviation abnormality and the device alarm is generated by the alarm generator 6. Here, “d” is a coefficient to adjust the influence of the deviation. The threshold value determined for the occurrence of the deviation abnormality has 9 types, which are obtained by selecting the coefficient “d” from a value range of 2 to 6 in 0.5 increments.

With respect to the binary abnormality, when a binary device parameter, which expresses an alarm log generated by the exposure device itself by value of 0 or 1, is equal to one of the values, binary abnormality is judged to occur and the device alarm is generated by the alarm generator 6. There are two types of conditions under which the binary abnormality occurs, i.e. namely the case where the value is 0 and the case where the value is 1.

After that, the alarm selector 12 checks the device alarm with the trouble based on the information such as a lot number, wafer number, processing date and time, etc. stored in the manufacturing management database 15, and calculates a trouble hitting ratio H(i,j), a trouble detection rate D(i,j), and significance P (i,j) relating to the i-th device alarm (device alarm i) and the j-th trouble (the trouble j) (Step S44).

The trouble hitting ratio H(i,j) is the concordance rate between the device alarm i and the trouble j, namely, an index to represent the concordance proportion of the device alarm i to the trouble j. The trouble hitting ratio H(i,j) can be expressed by the following equation (7).

H(i,j)=(the number of the cases where the device alarm i and the trouble j occur at the same time)/(the number of occurrences of the device alarm i) (7)

For example, if H(i,j)=100%, the trouble j inevitably occurs when the device alarm i is generated. Further, if H(i,j)=0%, the device alarm i and the trouble j do not relate to each other.

Further, the trouble detection rate D(i,j) is an index to represent the proportion of the trouble j detected by the device alarm i. The trouble detection rate D(i,j) can be expressed by the following equation (8).

D(i,j)=(the number of the cases where the device alarm i and the trouble j occur at the same time)/(the frequency of the trouble j) (8)

When the value of the trouble detection rate D(i,j) with respect to every device alarm i is low, the number of device alarms to detect the trouble j is lacking.

The significance P(i,j) is calculated based on the above equations (1) to (6) as in the first embodiment, for example.

The alarm selector 12 calculates the trouble hitting ratio H(i,j), the trouble detection rate D(i,j), and the significance P(i,j) with respect to every combination (i,j) (Step S45). Concretely, i represents 1 to 27,500 (27,500=250 device parameters to be acquired *(9 types of value range abnormality+90 types of trend abnormality+9 types of deviation abnormality+2 types of binary abnormality)), and j represents 0 to 3 (0 represents the occurrence of any one of all troubles, and 1 to 3 represent the dimension abnormality rework, the alignment gap abnormality rework, and the focus abnormality rework, respectively).

Next, in Steps S46 to S58, the alarm selector 12 sets the importance level and the control range of each device alarm based on the significance P(i,j) and the trouble hitting ratio H(i,j).

First, the alarm selector 12 extracts the device alarm i having the maximum trouble hitting ratio H(i,j) and significant relationship with respect to each combination of the device parameter k and the trouble j (Step S46). Whether or not the significant relationship is judged based on the significance P(i,j). For example, as in the first embodiment, when the value of the significance P(i,j) is 0.05 or less, it is judged to be significant. Further, when a plurality of device alarms i have the maximum trouble hitting ratio, the device alarm whose value i is the smallest is extracted, for example.

Next, when the extracted device alarm i has a trouble hitting ratio H(i,j) of 80% or greater, the importance level of the extracted device alarm i concerning the trouble j is set “high” (Steps S47a and S48). Similarly, when the trouble hitting ratio H(i,j) is 30% or greater but less than 80%, the importance level of the extracted device alarm i concerning the trouble j is set “middle” (Steps S47b and S49), and when the trouble hitting ratio H(i,j) is 30% or less, the importance level of the extracted device alarm i concerning the trouble j is set “nothing” (Step S50).

The alarm selector 12 stores, in the importance level database 31, the importance level set for each device alarm (Step S51). The alarm selector 12 performs the process of Steps S46 to S51 on every combination (k,j) (Step S52).

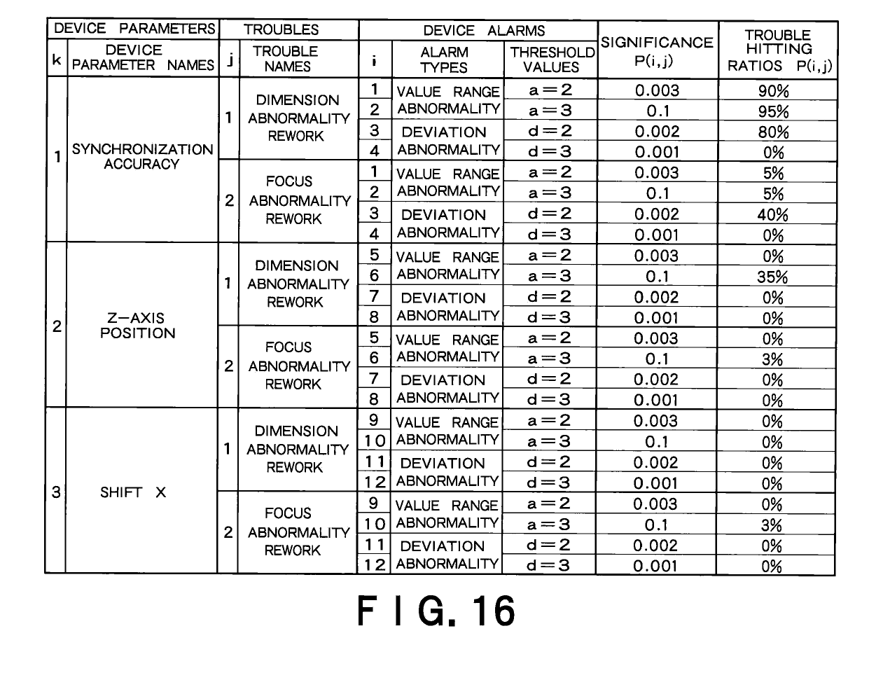

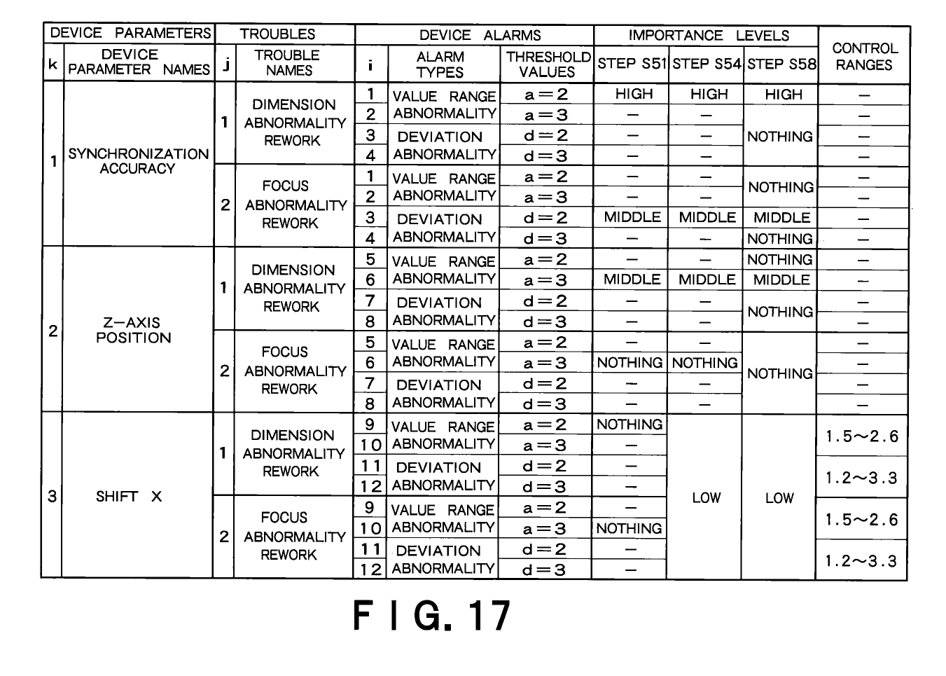

FIG. 16 is a diagram showing an example in which the trouble hitting ratio H(i,j) of the device alarm is categorized based on the combination of the device parameter k and the trouble j. FIG. 17 is a diagram showing an example in which the importance level and the control range are set with respect to each device alarm i. The importance level field in FIG. 17 shows the importance level set by each step of FIGS. 15A and 15B. Here, each of FIGS. 16 and 17 shows, for simple explanation, 2 types of troubles (j=1,2), 3 types of device parameters (k=1 to 3), 2 types of alarms (the value range abnormality and the deviation abnormality), and 2 types of threshold values for the alarms, by which the total number of device alarms is 12 (i=1 to 12). For example, in FIG. 16, with respect to the combination of the device alarm “value range abnormality (a=2)” (i=1) relating to the device parameter “synchronization accuracy” (k=1), the trouble hitting ratio of the trouble “dimension abnormality rework” (j=1) is 90%, and the trouble hitting ratio of the trouble “focus abnormality rework” (j=2) is 5%. A concrete example of Steps S46 to S52 will be explained referring to FIGS. 16 and 17.

In the example of FIG. 16, with respect to the combination of the device parameter “synchronization accuracy” (k=1) and the trouble “dimension abnormality rework” (j=1), the alarm selector 12 extracts the device alarm “value range abnormality (a=2)” (i=1) having the maximum trouble hitting ratio H(i,j) among the device alarms judged to be significant as having a significance P(i,j) of 0.05 or less (Step S46 in FIG. 15A). Since the trouble hitting ratio H(1,1) is 90% (Step S47), the importance level of the device alarm “value range abnormality (a=2)” (i=1) concerning “the synchronization accuracy” is set “high” with respect to the trouble “dimension abnormality rework” (Steps S48 and S51, FIG. 17).

Further, in the example of FIG. 16, with respect to the combination of the device parameter “synchronization accuracy” (k=1) and the trouble “focus abnormality rework” (j=2), the importance level of the device alarm “deviation abnormality (d=2)” (i=3) is set “middle.” Next, similarly, the importance level of the device alarm i is set with respect to each different combination of the device parameter k and the trouble j, and consequently the importance levels of 6 types of (k=1 to 3, j=1,2) device alarms are set (Steps S46 to S52 of FIG. 15A, FIG. 17).

Referring back to FIG. 15B, when every trouble hitting ratio H(i,j) of the device alarm i relating to the device parameter k is less than 30%, the alarm selector 12 sets every importance level of the device alarm i “low,” and stores the importance level in the importance level database 31 (Step S54). When the importance level of the device alarm i is already set “nothing,” the importance level is changed “low.”

In the example of FIG. 16, every trouble hitting ratio H(i,j) of the device alarm i (i=9 to 12) relating to the device parameter “shift X” (k=3) is less than 30%. Accordingly, the importance level of each of eight device alarms i relating to “the shift X” is set “low” (Step S54, FIG. 17). In Steps S46 to S52, the importance level of the device alarm “value range abnormality (a=2)” (i=9) with respect to the combination of the device parameter “shift X” and the trouble “dimension abnormality rework”, and the importance level of the device alarm “value range abnormality (a=3)” (i=10) with respect to the combination of the device parameter “shift X” and the trouble “focus abnormality rework” are both set “nothing” once and changed to be “low” in Step S54.

As stated above, the device parameter k whose importance level is set “low” is considered to cause no trouble in the past three months. However, any trouble may occur if such device parameters k exceed the fluctuation range in the past three months. Accordingly, the fluctuation range of the device parameter k in the past three months is set as the control range (Step S55). Details will be explained hereinafter.

The control range of the value range abnormality is set to be the range between the minimum value and the maximum value in the fluctuation range. The control range of the trend abnormality is set to be a changing rate which is the largest in one day. The control range of the deviation abnormality is set to be the maximum difference value between the wafers or lots. Note that the control range of the binary abnormality is not set.

The control range of the device alarm i set as stated above is stored in the importance level database 31 (Step S56).

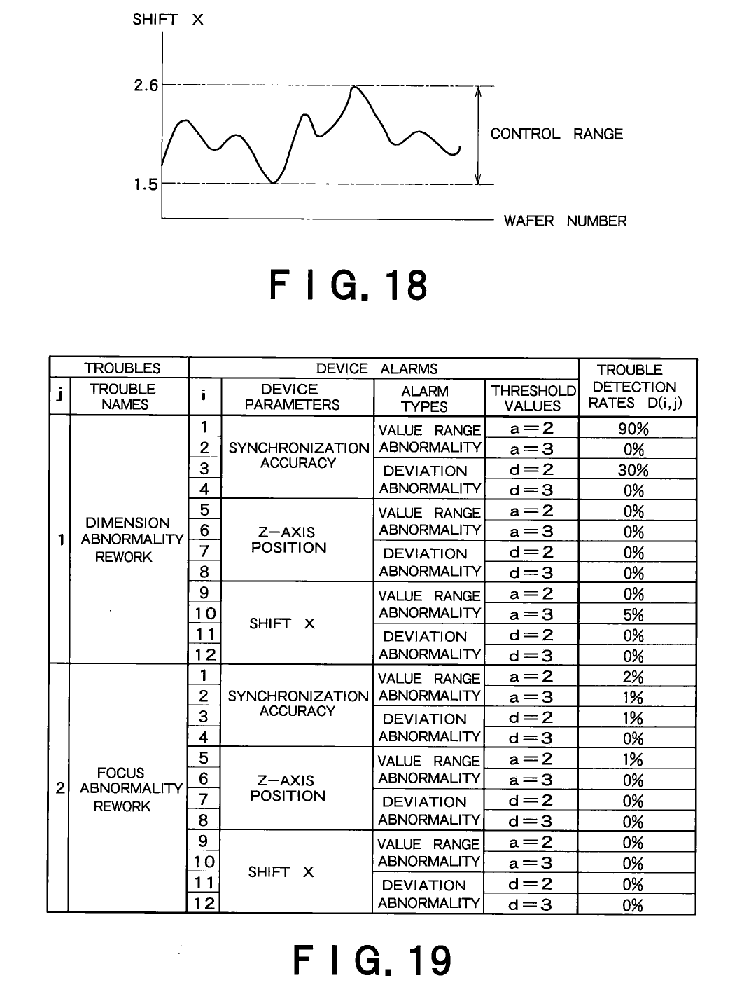

FIG. 18 is a graph showing an example of the fluctuation in the device parameter “shift X” in the past three months. The horizontal axis shows the wafer number manufactured in the past three months, and the vertical axis shows the value of the shift X. In this period, since the minimum value of the shift X is 1.5, and the maximum value is 2.6, the control range of the value range abnormality is set to be “1.5 to 2.6” (Step S55 of FIG. 15B, FIG. 17). Further, the control range of the deviation abnormality etc. is set as stated above.

After that, the alarm selector 12 sets the importance levels of the device parameters i having no importance level to be “nothing,” and stores the importance levels in the importance level database 31 (Step S58).

In the example of FIG. 16, with respect to the device alarm i (i=2 to 4) concerning the combination of the device parameter “synchronization accuracy” (k=1) and the trouble “dimension abnormality rework” (j=1), the device alarms i (i=1,2,4) concerning the combination of the device parameter “synchronization accuracy” and the trouble “focus abnormality rework” (j=2), etc, the importance levels are set as “nothing,” and the importance levels are stored in the importance level database 31 (Step S58, of FIG. 15B, FIG. 17).

As stated above, the importance level of the device alarm i concerning each combination of the device parameter k and the trouble j is set, and data as shown in FIG. 17 (the final Step S58 concerning the importance level) is stored in the importance level database 31. The above Steps S46 to S58 correspond to an importance level setting part. Note that the control range of the device parameter is set only when the importance level of the device parameter is “low.”

After that, the alarm selector 12 judges whether or not each trouble j is successfully detected. Concretely, first, the alarm selector 12 judges whether or not the maximum value of the trouble detection rate D(i,j) concerning the trouble j is a predetermined threshold (30%, for example) value or less (Step S59). When the maximum value of the trouble detection rate D(i,j) is the threshold value or less, the user terminal 13 presents the information that new device parameter should be added since device parameters to detect the trouble j is not enough (Step S60). The alarm selector 12 performs the judgment as stated above on every trouble j (Step S61).

Step S59 corresponds to a trouble detection rate judging part, and Step S60 corresponds to a device parameter change verifying part.

FIG. 19 is a diagram showing an example in which the trouble detection rate D(i,j) is categorized based on the trouble j. FIG. 19, which is simplified as in FIG. 16, etc., shows a different value example from FIG. 16, etc. The maximum value of the trouble detection rate D(i,j) of the trouble “dimension abnormality rework” (j=1) is 90% (i=1, that is, the device alarm “value range abnormality (a=2)” relating to the device parameter “synchronization accuracy”) exceeds the threshold value. Accordingly, it is judged that “the dimension abnormality rework” is detected with high accuracy. However, the maximum value of the trouble detection rate D(i,j) of the trouble “focus abnormality rework” (j=2) is 2% and does not exceed the threshold value. This means that “the dimension abnormality rework” cannot be sufficiently detected by the present device parameters. Accordingly, it is judged that a new device parameter is needed to detect “the dimension abnormality rework.”

By performing the above Steps S41 to S61 routinely (by the three months in the present embodiment, for example), the importance level and the control range can be updated, and a new device parameter can be added. If the update of the importance level etc. is not performed, the trouble cannot be appropriately detected in the case of temporary change of the manufacturing device, change of the products to be manufactured, etc. Therefore, the update of the importance level etc. is important.

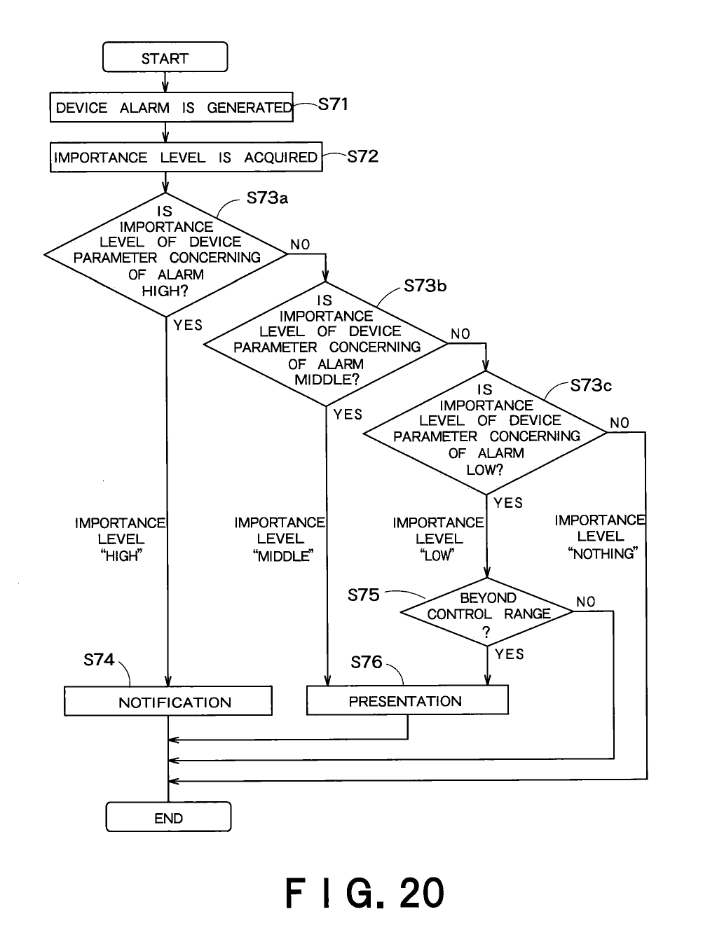

FIG. 20 is a flowchart showing the operating steps when the device alarm is generated in the manufacturing process. In a daily manufacturing process, when the device alarm is generated, the following steps are performed in accordance with the importance level and the control range of the device alarm stored in the importance level database 31.

The alarm generator 6 generates the device alarm by the above technique (Step S71). When the device alarm is generated, the alarm selector 12 acquires the importance level of the device alarm from the importance level database 31 (Step S72), and performs the following process in accordance with the importance level (Steps S73a to S73c).

When the importance level is “high,” the alarm notification part 32 promptly notifies the information to the mobile terminal of an operator, engineer, etc. in the field (Step S74). This is because the trouble occurs with extremely high possibility. The alarm notification part 32 notifies at least the generation of the alarm, the device parameter name, and the trouble name. Further, it is desirable to notify specific information such as the name and number of the device generating the device parameter, the position of the device in the clean room 21, etc. Further, a warning beep can be generated in the clean room 21. By receiving the notification, the operator etc. can quickly respond to the device alarm, and the influence of the trouble can be minimized.

When the importance level is “middle,” the user terminal 13 presents the generation of the device alarm (Step S76). When the importance level is “middle,” the trouble may not occur in some cases, and may occur in other cases. The information to be presented is as stated above. It is desirable that the user terminal 13 is arranged in a prominent position for the operator etc., and that a plurality of user terminals 13 are arranged. Further, a warning beep can be generated in the clean room 21. Accordingly, when the trouble occurs, the device parameter assumed to be the trouble cause can be identified with high probability from the information presented by the user terminal 13. Further, since the information is only presented by the user terminal 13, it is possible to prevent the notification from given to the operator etc. with excessive frequency. Step S76 corresponds to an alarm presentation part.

When the importance level is “low,” whether the device parameter exceeds the control range is further judged (Step S75), and the presentation to the user terminal 13 is performed only when the device parameter exceeds the control range (Step S76). Further, when the importance level is “nothing,” neither the notification nor presentation is not performed in order to monitor only the device alarm assumed to relate to the trouble with high possibility.

In the present embodiment, it is assumed that the threshold values to categorize the importance level are set to be 30% and 80%. However, these threshold values can be arbitrarily set, and can be changed as needed. Further, the troubles other than reworks can be acquired. Such troubles are, for example, “yield degradation abnormality” showing that the yield in a certain period lowers a certain proportion, “measured value abnormality” showing that the dimension of a specific part is abnormal, etc.

The trouble hitting ratio H(i,j) is required to be only the index which is calculated based on the relationship between the device alarm i and the trouble j to represent the concordance rate of the device alarm i to the trouble j, and is not necessarily required to be defined by the equation (7). Similarly, the trouble detection rate D(i,j) is required to be only the index which is calculated based on the relationship between the device alarm i and the trouble j to represent the detection level of the trouble j, and is not necessarily required to be defined by the equation (8).

In the present embodiment, it is assumed that 250 device parameters are acquired. However, hundreds of thousands of device parameters are actually existent, and it is extremely difficult to monitor all of the device parameters. With the present embodiment as stated above, the device parameters and the device alarms which should be truly monitored can be extracted, and the manufacturing process can be efficiently performed.

Further, the alarm reporting part 33 is not necessarily required to have both of the user terminal 13 and the alarm notification part 32. It is possible to arrange either one of them, and how to present the device alarm can be switched in accordance with the importance level. For example, the device alarm having a high importance level can be distinctively displayed on the screen, or can be reported by increasing the volume of the warning beep to attract attention. On the other hand, the device alarm having a not-so-high importance level can be indistinctively displayed on the screen, or can be reported by decreasing the volume of the warning beep.

As stated above, in the third embodiment, the importance level of the device alarm is set based on the relationship between the device alarm and the trouble, and when the device alarm is generated, how to present the device alarm, for example, notification to the operator etc., presentation to the user terminal, or nothing, is switched in accordance with the importance level. Therefore, only the device alarms having a high importance level to be monitored can be acquired, and the trouble can be efficiently dealt with in the manufacturing process. Further, since the importance level of the device alarm is periodically updated, the device alarms to be monitored can be always acquired even in the case of temporary change of the manufacturing device, change of the product to be manufactured, etc.

In the example of each embodiment as stated above, the explanation is made on the technique to detect the trouble of the manufacturing device 1 used in the semiconductor manufacturing process. However, the present invention is not limited to the semiconductor manufacturing process, and can be employed to detect the trouble of various manufacturing devices used in the manufacturing process. For example, the present invention can be applied to the case where a painting device is used instead of the manufacturing device 1 in the manufacturing process of an automobile.

At least a part of the failure cause identifying device explained in the above embodiments can be formed of hardware or software. When the failure cause identifying device is partially formed of the software, it is possible to store a program implementing at least a partial function of the failure cause identifying device in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the failure cause identifying device can be distributed through a communication line (including radio communication) such as the Internet etc. Furthermore, the program which is encrypted, modulated, or compressed can be distributed through a wired line or a radio link such as the Internet etc. or through the recording medium storing the program.

Although based on above description, those skilled in the art can figure out additional effects and variations of the present invention, the aspect of the present invention is not limited to the stated each embodiments. Various additions, alterations and partial deletions can be done to the present invention within the conceptualistic thought and purpose of the present invention drawn on the claims and the equivalents.

1. A failure cause identifying device, comprising:
a device parameter acquisition part configured to acquire a device parameter indicative of an operating state of a manufacturing device;
an alarm generator configured to generate a device alarm with respect to the device parameter in accordance with a predetermined rule during the operation of the manufacturing device;
a trouble acquisition part configured to acquire information relating to at least a part of troubles occurred in the manufacturing device;
a significance detector configured to detect significance of a relationship between the device alarm and the trouble; and
a significance judging part configured to judge whether or not a relationship between the device parameter and the trouble is significant based on the significance detected by the significance detector.

2. The device of claim 1, further comprising:
a trend chart generator configured to generate a trend chart indicative of the relationship between the device alarm and the trouble with respect to each of the device parameters based on the judgment result of the significance judging part; and
a presentation part configured to present the trend chart.

3. The device of claim 1, further comprising:
a trend chart generator configured to generate a trend chart indicative of the relationship between the device alarm and the trouble with respect to each of the device parameters based on the judgment result of the significance judging part; and
a manufacturing device controller configured to control a setting condition of the manufacturing device based on the trend chart.

4. The device of claim 3, wherein the manufacturing device controller determines, based on the trend chart, a margin degree of the device parameter for preventing occurrence of the trouble, and controls the setting condition of the manufacturing device in order to prevent the device parameter from deviation of the margin degree.

5. The device of claim 1, further comprising:
an importance level setting part configured to calculate a trouble hitting ratio indicative of a coincidence degree between the device alarm and the trouble based on the relationship between the device alarm and the trouble, and to set an importance level with respect to the device alarms based on the judgment result of the significance judging part and the trouble hitting ratio; and
an alarm reporting part configured to switch how to present the device alarm in accordance with the importance level when the device alarm occurs.

6. The device of claim 5, wherein the importance level setting part updates the importance level by a predetermined period.

7. The device of claim 6,
wherein the importance level setting part sets a control range serving as a reference for presenting at least a part of the device alarms based on a fluctuation range of the device parameter in the predetermined period, and
the alarm reporting part switches how to present the device alarm in accordance with at least one of the importance level and the control range.

8. The device of claim 7, wherein the alarm reporting part switches how to present the device alarm based on whether or not the device parameter is in the control range only when the importance level meets a predetermined condition.

9. The device of claim 5, further comprising:
a trouble detection rate calculator configured to calculate a trouble detection rate indicative of a detection level of each of the troubles based on the relationship between the device alarm and the trouble;
a trouble detection rate judging part configured to judge whether or not the trouble detection rate corresponding to each of the troubles is equal to or less than a predetermined threshold value; and
a device parameter change verifying part configured to verify whether or not the device parameter relating to the trouble should be added when the trouble detection rate is judged to be equal to or less than the predetermined threshold value.

10. The device of claim 1, wherein the significance detector detects the significance based on an expected value and a measured value in each of four cases: the case where the device alarm and the trouble occur at the same time; the case where only the device alarm is generated; the case where only the trouble occurs; and the case where the device alarm and the trouble do not occur.

11. A failure cause identifying method comprising the steps of:
acquiring a device parameter indicative of an operating state of a manufacturing device;
generating a device alarm with respect to the device parameter in accordance with a predetermined rule during the operation of the manufacturing device;
acquiring information relating to at least a part of troubles occurring in the manufacturing device;
detecting significance of a relationship between the device alarm and the trouble; and
judging whether or not the relationship between the device parameter and the trouble is significant based on the significance.

12. The method of claim 11, further comprising the steps of;
generating a trend chart indicative of the relationship between the device alarm and the trouble with respect to each of the device parameters based on the judgment result of whether or not the relationship of the device parameter and the trouble is significant; and
presenting the trend chart.

13. The method of claim 11, further comprising the steps of;
generating a trend chart indicative of the relationship between the device alarm and the trouble with respect to each of the device parameters based on the judgment result of whether or not the relationship of the device parameter and the trouble is significant; and
controlling a setting condition of the manufacturing device based on the trend chart.

14. The method of claim 13, wherein at the step of controlling a setting condition, a margin degree of the device parameter is determined based on the trend chart for preventing occurrence of the trouble, and the setting condition of the manufacturing device is controlled in order to prevent the device parameter from deviation of the margin degree.

15. The method of claim 11, further comprising the steps of;
calculating a trouble hitting ratio indicative of a coincidence degree between the device alarm and the trouble based on the relationship between the device alarm and the trouble, and setting an importance level with respect to the device alarm based on the judgment result of the significance judging part and the trouble hitting ratio; and
switching how to present the device alarm in accordance with the importance level when the device alarm occurs.

16. The method of claim 15, wherein the importance level is updated by a predetermined period.

17. The method of claim 16, wherein at the step of setting the importance level, a control range serving as a reference for presenting at least a part of the device alarms is set based on a fluctuation range of the device parameter in the predetermined period, and
at the step of switching how to present the device alarm, how to present the device alarm is switched in accordance with at least one of the importance level and the control range.

18. The method of claim 17, wherein at the step of switching how to present, the way to present the device alarm is switched based on whether or not the device parameter is in the control range only when the importance level meets a predetermined condition.

19. The method of claim 15, further comprising the steps of;
calculating a trouble detection rate indicative of a detection level of each of the troubles based on the relationship between the device alarm and the trouble;
judging whether or not the trouble detection rate corresponding to each of the troubles is equal to or less than a predetermined threshold value; and
verifying whether or not the device parameter relating to the trouble should be added when the trouble detection rate is judged to be equal to or less than the predetermined threshold value.

20. The method of claim 11, wherein the significance is detected based on an expected value and a measured value in each of four cases: the case where the device alarm is generated and the trouble occurs at the same time; the case where only the device alarm is generated; the case where only the trouble occurs; and the case where the device alarm is not generated and the trouble does not occur.
